(19) United States
(12) Patent Application Publication
(10) Pub. No.: US 2026/0048791 A1
(43) Pub. Date: Feb. 19, 2026

(54) CLOSED BEAM ASSEMBLY AND METHOD FOR CONTROLLED MATERIAL FRACTURE THEREOF

(71) Applicant: Honda Motor Co., Ltd., Tokyo (JP)

(72) Inventors: Amir OUESLATI, Marysville, OH (US); Kishore K. PYDIMARRY, Dublin, OH (US)

(21) Appl. No.: 18/808,853

(22) Filed: Aug. 19, 2024

(51) Int. Cl. B62D 21/15; G01M 7/08

(52) U.S. Cl. CPC B62D 21/15; G01M 7/08

(57) ABSTRACT

A closed beam assembly and method for controlled material fracture thereof for a vehicle includes a hat-shaped member having a raised wall portion, supporting sidewall portions spaced apart from one another and depending from the raised wall portion, and flange wall portions extending outwardly from distal ends of the supporting sidewall portions. The closed beam assembly further includes a flat member mated with the flange wall portions to define a closed cross-section and a notched pattern defined in the raised wall portion of the hat-shaped member for controlled material fracture when the hat-shaped member is subjected to an impact load.

### BACKGROUND

Previously, in the automotive industry, full vehicle simulation has been increasingly used in the design process of new structures. As part of this, a lot of demand is placed on the predictive accuracy of the mathematical models used in this process. In this context, the mathematical modeling of damage models and their experimental validation tests can be important. The material behavior and corresponding damage can be generally calibrated in a quasi-static loading condition using coupons covering various states of stress and deformation. The validation of these models relies on component testing and correlation with the simulation.

In the case of sheet metal materials, the failure can be difficult to control during component testing, and the same setup could lead to different results, thus making the correlation challenging. Typical thin metal parts have highly variable impact deformation modes. Under impact, fracture of the material can be difficult to control, which can lead to highly variable responses. One example is in the case of automotive low-strength steel. In the case of this testing, under the same test conditions, the component may present different buckling modes without failure. There is a need for better control of impact response (e.g., fracture versus no facture) of thin metal parts, which could be used to better control and/or predict performance under loading.

### BRIEF DESCRIPTION

According to one aspect, a closed beam assembly for a vehicle includes a hat-shaped member having a raised wall portion, supporting sidewall portions spaced apart from one another and depending from the raised wall portion, and flange wall portions extending outwardly from distal ends of the supporting sidewall portions. The closed beam assembly further includes a flat member mated with the flange wall portions to define a closed cross-section and a notched pattern defined in the raised wall portion of the hat-shaped member for controlled material fracture when the hat-shaped member is subjected to an impact load.

According to another aspect, a method for controlled material facture in a vehicle closed beam assembly includes providing a hat-shaped member having a raised wall portion, supporting sidewall portions spaced apart from one another and depending from the raised wall portion, and flange wall portions extending outwardly from distal ends of the supporting sidewall portions. The method also includes providing a flat member mated with the flange wall portions to define a closed cross-section, wherein a notched pattern is defined in the raised wall portion of the hat-shaped member for controlled material fracture when the hat-shaped member is subjected to an impact load.

According to a further aspect, a notched pattern on a closed beam assembly for predictably controlling material fracture of the closed beam assembly includes a first aperture defined in a raised wall portion of a hat-shaped member. The hat shaped member has the raised wall portion, supporting sidewall portions spaced apart from one another and depending from the raised wall portion, and flange wall portions extending outwardly from distal ends of the supporting sidewall portions. The notched pattern further includes a second aperture defined in the raised wall portion. A flat member is mated with the flange wall portions to define a closed cross-section and the first aperture is elongated relative to the second aperture.

### BRIEF DESCRIPTION OF THE DRAWINGS

FIG. 1 is a perspective view of a closed beam assembly for a vehicle having a notched pattern defined therein for controlled material fracture according to one aspect.

FIG. 2 is a cross-section view of the closed beam taken along the line 1-1 of FIG. 1.

FIG. 3A is a partial enlarged view of the notched pattern of FIG. 1.

FIG. 3B is a partial enlarged view of an alternative notched pattern.

FIG. 3C is a partial enlarged view of another alternative notched pattern.

FIG. 3D is a partial enlarged view of yet another alternative notched pattern.

FIG. 4 is a schematic perspective view of an impact tool having the closed beam assembly loaded thereon for application of an impact load for determining a precise fracture point for the closed beam assembly.

FIGS. 5A-5D graphically illustrate a correlation between failure of various notched patterns and CAE failure simulation.

FIG. 6 is an exemplary flow diagram of a method for controlled material fracture of the closed beam assembly.

### DETAILED DESCRIPTION

It should of course be understood that the description and drawings herein are merely illustrative, and that various modifications and changes can be made in the structures disclosed without departing from the present disclosure. Spatially defined terms may be used to describe an element and/or feature's relationship to other element(s) and/or feature(s) as, for example, illustrated in the figures. Moreover, any term of degree used herein, such as “substantially” and “approximately,” means a reasonable amount of deviation of the modified work is contemplated such that the end result is not significantly changed.

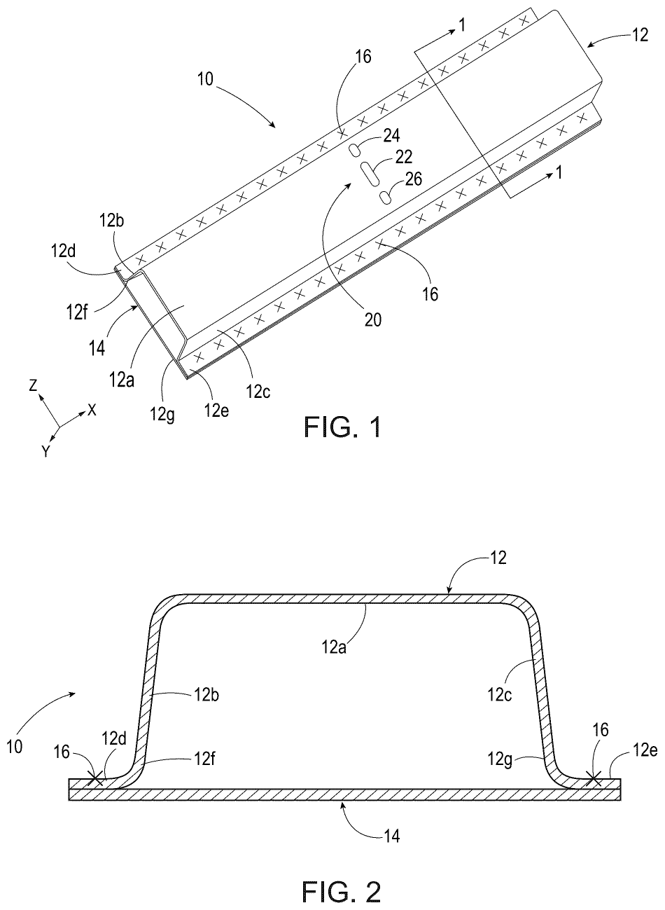

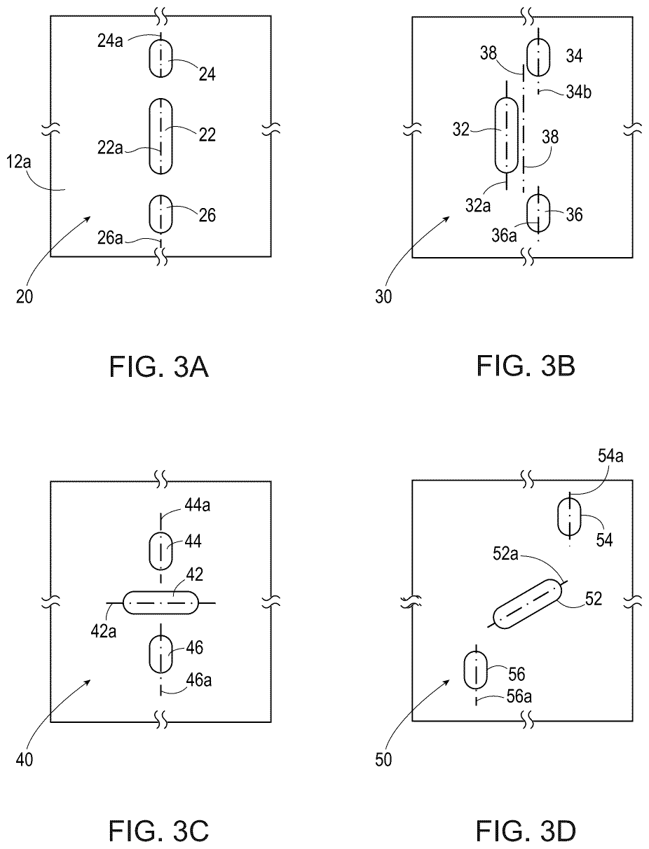

Referring now to the drawings, wherein like numerals refer to like parts throughout the several views, FIGS. 1 and 2 illustrates a closed beam assembly 10 for a vehicle according to one embodiment of the present disclosure. The closed beam assembly 10 can be one of the many closed beam assemblies used on vehicles. For example, the closed beam assembly could be a side sill member, a pillar member, a cross beam member, a frame member, etc. In the illustrated embodiment, the closed beam assembly 10 includes a hat shaped member 12 having a raised wall portion 12a, supporting sidewall portions 12b, 12c spaced apart from one another and depending from the raised wall portion 12a, and flange wall portions 12d, 12e extending outwardly from distal ends 12f, 12g of the supporting sidewall portions 12b, 12c.

The closed beam assembly 10 also includes a flat member 14 mated with the hat shaped member 12, and particularly mated with the flange wall portions 12d, 12e of the hat shaped member to define a closed cross-section for the closed beam assembly 10. In one embodiment, the flat member 14 is secured to the hat shaped member 12 via welds 16. In particular, a plurality of welds 16 can be used along a longitudinal extent of the flange wall portions 12d, 12e and corresponding portions of the flat member 14.

In one example, the hat shaped member 12 and/or the flat member 14 can be formed from a metal or alloy sheet, such as a steel sheet. In a more particular example, the hat shaped member 12 and/or the flat member 14 can be provided or formed from JAC1180 sheet steel. An exemplary thickness for each of the hat shaped member 12 and the flat member 14 can be 1.4 mm thick. Of course, it is to be appreciated that other materials and/or metals (or alloys) could be used and other thicknesses could be employed. In another embodiment, the members 12 and 14 could be formed of extruded aluminum.

In one exemplary embodiment, the raised wall portion 12a can have a longitudinal dimension of about 80 mm. A radius of about 5.0 mm can be provided between the raised wall portion 12a and the supporting sidewall portions 12b with an inner radial dimension between the raised wall portion 12a and the supporting sidewall portions 12b being 100°. In this embodiment, the sidewall portions can have a length dimension of about 35 mm. The height of the raised wall portion 12a relative to the flange wall portions 12d, 12e can be about 44 mm. A length of the flange wall portions 12d can be about 15 mm. A radius of 5 mm can be provided between the supporting sidewall portions 12b and the flange wall portions 12d, 12e at the distal ends, 12f, 12g, respectively. Of course, other dimensions and arrangements could be employed.

In the illustrated embodiment, the closed beam assembly 10 further includes a notched pattern 20 defined in the raised wall portion 12a of the hat shaped member 12 for controlled material fracture of the beam assembly 10 when the closed beam assembly 10, and particularly the hat shaped member 12, is subjected to an impact load as will be described in further detail below. The notched pattern 20 advantageously allows for systematic and precisely controlled failure of the closed beam assembly 10, and particularly of the hat shaped member 12. This allows for simplified computer simulation of the failure for the closed beam assembly 10 and thereby enhanced computer modeling.

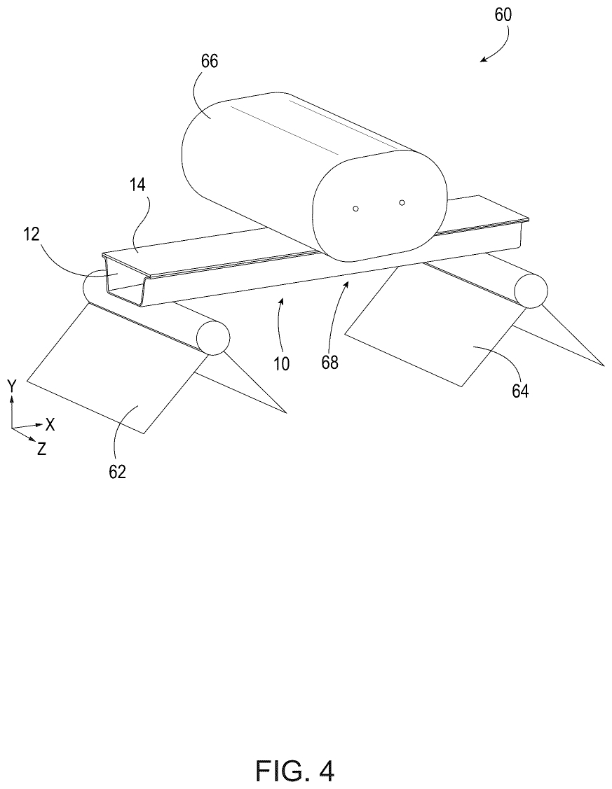

With additional reference to FIG. 3a, the notched pattern 20 includes a plurality of apertures (e.g., apertures 22, 24, 26) defined in the raised wall portion 12a. The plurality of apertures includes at least a first aperture 22 and a second aperture 24. As shown, the first aperture 22 can be elongated relative to the second aperture 24. The plurality of apertures can further include a third aperture 26 that is sized the same as the second aperture 24. As shown, each of the first, second, and third apertures 22, 24, 26 can be slot shaped apertures with the first aperture 22 having an elongation that is longer than that of the second and third apertures 24, 26. As shown, the second and third apertures 24, 26 can flank the first aperture 22. That is, the second and third apertures 24, 26 can be provided at opposite ends of the first aperture 22. Stated another way, the second and third apertures 24, 26 can have, respectively, a second aperture major axis 24a and a third aperture major axis 26a, which are arranged to be colinear with one another. The first aperture 22 can have a first aperture major axis 22a arranged to be colinear with both the second aperture major axis 24a and the third aperture major axis 26a. The axes 22a, 24a, and 26a can extend across the hap shaped member 12, and particularly across the raised wall portion 12a of the hat shaped member 12, so as to be parallel to a width of the hat shaped member 12 and perpendicular relative to a longitudinal length of the hat shaped member 12.

As shown, the notched pattern 20 can be provided in a center location relative to a longitudinal length of the closed beam assembly 10, and particularly relative to a longitudinal length of the hat shaped member 12. In one embodiment, the hat shaped member 12 can have a longitudinal length of about 600 mm and the flat member 14 can have the same longitudinal length. Of course, other longitudinal lengths could be used.

In the illustrated embodiment, and in one specific embodiment, the first aperture can have a longitudinal dimension of about 28 mm and a width dimension of about 10 mm. The second and third apertures 22, 26 can each have a longitudinal dimension of about 14 mm (i.e., half the longitudinal length of the first aperture 22) and a width dimension of about 10 mm (i.e., the same width dimension as the first aperture 22). The radial dimension for all of the apertures 22, 24, 26 can be about 5 mm. A spacing dimension between the first aperture 22 and each of the second aperture 24 and the third apertures 26 can be about 8 mm.

With reference to FIG. 3B, a notched pattern 30 is illustrated that can be substituted for the notched pattern 20. The notched pattern 30 can include first aperture 32, second aperture 34, and third aperture 36. Except as described herein, the notched pattern 30 and the first aperture 32, the second aperture 34, and the third aperture 36 can be the same as, respectively, the notched pattern 20 and the first aperture 22, the second aperture 24, and the third aperture 26. As shown, the first aperture 32 has a first aperture major axis 32a arranged so as to be parallel to the second aperture major axis 34a and the third aperture major axis 36a. Unlike the notched pattern 20, the first aperture major axis 32a is offset relative to the second aperture major axis 34a and the third aperture major axis 36a so that the first aperture 32 is offset relative to the second and third apertures 34, 36. In one example, the first aperture 32 is offset by about 13 mm relative to the second and third apertures 34, 36. Also, and by example only, the first aperture 32 and the second and third apertures 34, 36 can each be offset relative to a beam center plane 38 provided at a longitudinal middle of the hat shaped member 12.

With reference to FIG. 3C, another notched pattern 40 is illustrated that can be substituted for the notched pattern 20. The notched pattern 40 includes first aperture 42, second aperture 44, and third aperture 46. Except as described herein, the apertures 42, 44, 46 and the notched pattern 40 can be the same as the notched pattern 20 and the first aperture 22, the second aperture 24, and the third aperture 26. The apertures 42, 44, 46 can respectively have a first aperture major axis 42a, a second aperture major axis 44a, and a third aperture major axis 46a. One difference relative to the notched pattern 20 is that the first aperture major axis 42a is arranged so as to be perpendicular relative to the second aperture major axis 44a and the third aperture major axis 46a, as shown. Spacing between the apertures can be about 8 mm.

With reference now to FIG. 3D, a notched pattern 50 is illustrated that can be substituted for the notched pattern 20. The notched pattern 50 includes first aperture 52 having first aperture major axis 52a, second aperture 54 having second aperture major axis 54a, and third aperture 56 having third aperture major axis 56a. Except as described herein, the notched pattern 50 and the first aperture 52, the second aperture 54, and the third aperture 56 can be the same as, respectively, the notched pattern 20 and the first aperture 20, the second aperture 24, and the third aperture 26.

One difference relative to the notch pattern 20 is that the first aperture major axis 52a is arranged so as to be arranged angularly disposed relative to the second aperture major axis 54a and the third aperture major axis 56a. By way of example, the first aperture 52, and particularly the first aperture major axis 52a, can be angularly disposed relative to the second aperture 54, and particularly the second aperture major axis 54a, and to the third aperture, and particularly the third aperture major axis 56a, at an angularly disposed angle between about 20°and about 60°. In particular, as shown in the illustrated embodiment of FIG. 3D, the angularly disposed angle can be about 30°. In an alternate embodiment, the angle could be 45°. Spacing between the apertures 52, 54, 56 can remain at 8 mm. In particular, the spacing dimension can be along a dimension parallel to the second and third major axes, 54a, 56a.

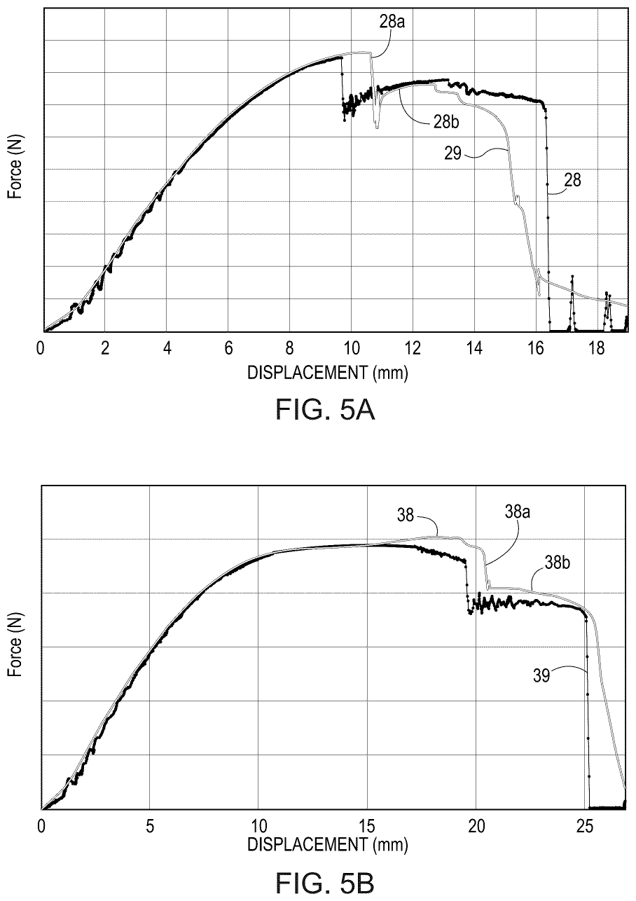

With reference now to FIG. 4, an elliptical impactor 60 is schematically illustrated. As shown, the elliptical impactor 60 can include base members 62, 64 on which the closed beam assembly 100, including the hat shaped member 12 and the flat member 14, can be supported. The elliptical impactor 60 includes an impactor member 66 that forcibly impacts the closed beam assembly 10. As shown, the impactor member 66 can be elliptically shaped. In particular, the impactor member 66 can impact the closed beam assembly 10 at the location 68 at which the notched pattern 20, or alternative notched patterns 30, 40, 50, is disposed. The elliptical impactor 60 can be used to determine precisely when the closed beam assembly 10 fails. In particular, the initiation of the failure can be graphically mapped on a displacement versus load graph and propagation of the failure can be mapped on the same graph. This can then be compared to CAE modeling to confirm correlation between actual failure and modeled failure.

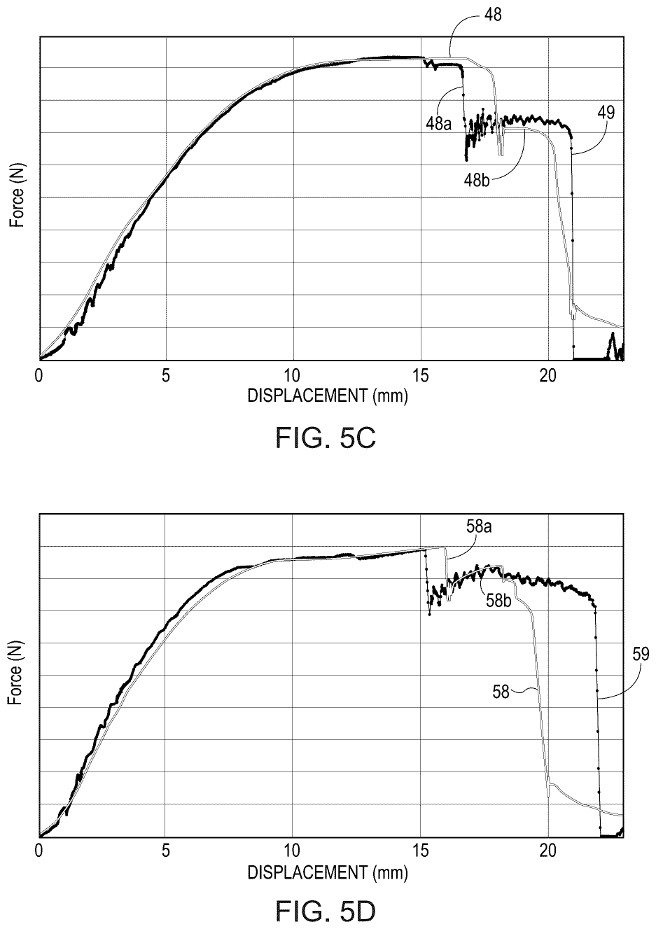

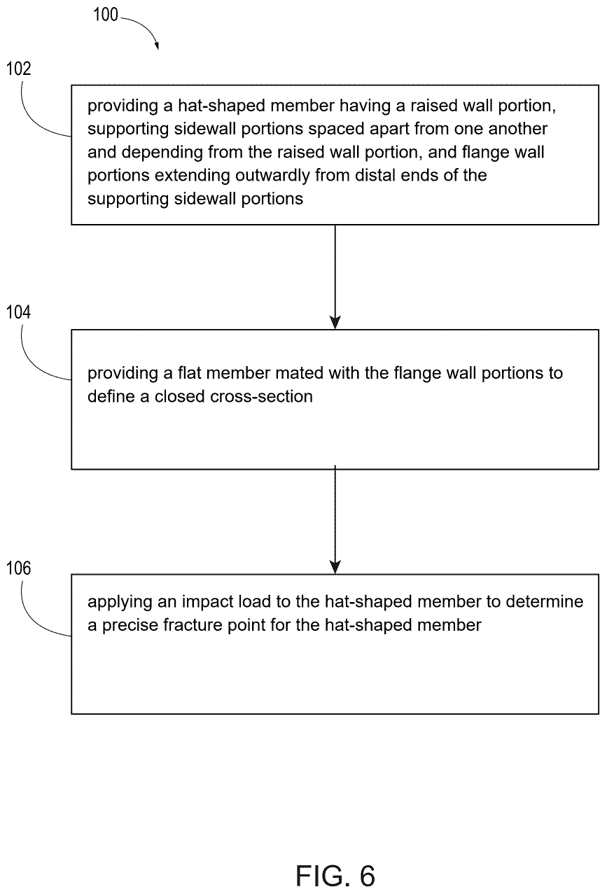

With reference now to FIGS. 5A-5D, correlation graphs are shown for each of the notched patterns 20, 30, 40 and 50. In particular, FIG. 5A corresponds to the notched pattern 20, FIG. 5B corresponds to the notched pattern 30, FIG. 5C corresponds to the notched pattern 40 and FIG. 5D corresponds to the notched pattern 50. Referring to FIG. 5A a displacement versus force graph is shown for the notched pattern 20 and represented by line 28. Notably, failure initiation occurs at 28a and is propagated across the hat section at 28b. Referring to FIG. 5B, a displacement versus force graph is shown for notched pattern 30 and represented by line 38. Notably, failure initiation occurs at 38a and is propagated across the hat section at 38b. Referring to FIG. 5C, a displacement versus force graph is shown for notched pattern 40 and represented by line 48. Notably, failure initiation occurs at 48a and is propagated across the hat section at 48b. Referring to FIG. 5D, a displacement versus force graph is shown for notched pattern 50 and represented by line 58. Notably, failure initiation occurs at 58a and is propagated across the hat section at 58b. In each of the graphs, CAE (computer aided engineering) lines 29, 39, 49 and 59 are shown that correspond very closely to lines 28, 38, 48 and 58, respectively. Accordingly, CAE modeling can be used due to its close correlation with actual failure in the raised hat section 12.

Referring now to FIG. 5, a method 100 for controlled material fracture in a vehicle closed beam assembly will be described. In particular, the method 100 of FIG. 5 will be described in association with the closed beam assembly 10 described herein above, that is to be appreciated that the method of FIG. 5 could be used with other closed beam assemblies 10. In the method 100, a hat shaped member 12 having raised wall portion 12a, supporting sidewall portions 12b, 12c spaced apart from one another and depending from the raised wall portion 12a and flange wall portions 12d, 12e extending outwardly from distal ends 12f, 12g of the supporting sidewall portions 12b, 12c is provided at 102.

Flat member 12 is provided at 104 and is particularly provided mated with flange wall portions 12d, 12e of the hat shaped member 12 to define a closed cross-section 40 closed beam assembly 10. Notched pattern 20, or one of the alternative notched patterns 30, 40, or 50 is defined in the raised wall portion 12a of the hat shaped member 12 for a controlled material fracture when the hat shaped member 12 is subjected to an impact load. At 106, an impact load can be applied to the hat shaped member 12 to determine a precise fracture point for the hat shaped member 12, and more generally for the closed beam assembly 10. In particular, the impact load can be applied at the location of the notched pattern 20. Also, the impact load can be applied by an elliptical impactor 60, such as the elliptical impactor described herein above.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A closed beam assembly for a vehicle, comprising:
a hat-shaped member having a raised wall portion, supporting sidewall portions spaced apart from one another and depending from the raised wall portion, and flange wall portions extending outwardly from distal ends of the supporting sidewall portions;
a flat member mated with the flange wall portions to define a closed cross-section; and
a notched pattern defined in the raised wall portion of the hat-shaped member for controlled material fracture when the hat-shaped member is subjected to an impact load.

2. The closed beam assembly of claim 1 wherein the notched pattern includes a plurality of apertures defined in the raised wall portion, wherein the plurality of apertures includes a first aperture and second aperture, wherein the first aperture is elongated relative to the second aperture.

3. The closed beam assembly of claim 2 wherein the plurality of apertures includes a third aperture that is sized the same as the second aperture.

4. The closed beam assembly of claim 3 wherein each of the first, second and third apertures are slot shaped apertures.

5. The closed beam assembly of claim 4 wherein the second and third apertures flank the first aperture.

6. The closed beam assembly of claim 5 wherein the second and third apertures have, respectively, a second aperture major axis and a third aperture major axis, which are arranged to be colinear with one another.

7. The closed beam assembly of claim 6 wherein the first aperture has a first aperture major axis arranged to be colinear with the second aperture major axis and the third aperture major axis.

8. The closed beam assembly of claim 5 wherein the first aperture has a first aperture major axis arranged so as to be perpendicular relative to the second aperture major axis and the third aperture major axis.

9. The closed beam assembly of claim 5 wherein the first aperture has a first aperture major axis arranged so as to be parallel to the second aperture major axis and the third aperture major axis.

10. The closed beam assembly of claim 9 wherein the first aperture major axis is offset relative to the second aperture major axis and the third aperture major axis.

11. The closed beam assembly of claim 5 wherein the first aperture has a first aperture major axis arranged so as to be angularly disposed relative to the second aperture major axis and the third aperture major axis.

12. The closed beam assembly of claim 11 wherein the first aperture is angularly disposed relative to the second aperture major axis and the third aperture major axis at an angularly disposed angle between about 20 degrees and about 40 degrees.

13. The closed beam assembly of claim 12 the angularly disposed angle is about 30 degrees.

14. A method for controlled material facture in a vehicle closed beam assembly, comprising:
providing a hat-shaped member having a raised wall portion, supporting sidewall portions spaced apart from one another and depending from the raised wall portion, and flange wall portions extending outwardly from distal ends of the supporting sidewall portions; and
providing a flat member mated with the flange wall portions to define a closed cross-section,
wherein a notched pattern is defined in the raised wall portion of the hat-shaped member for controlled material fracture when the hat-shaped member is subjected to an impact load.

15. The method of claim 14 further including:
Applying an impact load to the hat-shaped member to determine a precise fracture point for the hat-shaped member.

16. The method of claim 15 wherein the impact load is applied at the location of the notched pattern.

17. The method of claim 16 wherein the impact load is applied by an elliptical impactor.

18. The method of claim 14 wherein the notched pattern includes a plurality of apertures defined in the raised wall portion, wherein the plurality of apertures includes a first aperture and second aperture, wherein the first aperture is elongated relative to the second aperture, and wherein the plurality of apertures includes a third aperture that is sized the same as the second aperture, and further wherein each of the first, second and third apertures are slot shaped apertures and the second and third apertures flank the first aperture.

19. A notched pattern on a closed beam assembly for predictably controlling material fracture of the closed beam assembly, comprises:
a first aperture defined in a raised wall portion of a hat-shaped member, the hat shaped member having the raised wall portion, supporting sidewall portions spaced apart from one another and depending from the raised wall portion, and flange wall portions extending outwardly from distal ends of the supporting sidewall portions; and
a second aperture defined in the raised wall portion,
wherein a flat member is mated with the flange wall portions to define a closed cross-section, and
wherein the first aperture is elongated relative to the second aperture.

20. The notched pattern of claim 19 further including a third aperture that is sized the same as the second aperture, and further wherein each of the first, second and third apertures are slot shaped apertures and the second and third apertures flank the first aperture.
